(19) United States
(12) Patent Application Publication
(10) Pub. No.: US 2001/0014876 A1
(43) Pub. Date: Aug. 16, 2001

(54) Network system, auction server, digital content distributing system, and digital content distributing method

(75) Inventor: Shichiro Miyashita, Foster City, CA (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/780,068

(22) Filed: Feb. 9, 2001

(30) Foreign Application Priority Data
Feb. 16, 2000 (JP) 2000-38864

(51) Int. Cl. G06F 17/60

(52) U.S. Cl. 705/37; 705/14

(57) ABSTRACT

A system includes a content provider terminal, an advertisement provider terminal, a BtoB server, and a BtoC server, wherein the BtoB server and the BtoC server receive digital content from the content provider terminal over a communication network, collect advertising content to be attached to the received digital content from the advertisement provider terminal, assist the provider of the digital content and the provider of the advertising content in concluding a contract between them for attaching an advertisement which contract contains a condition concerning payment to the provider of the digital content, combine the digital content with the advertising content to produce digital content with advertisement, and publish it on the Internet.

### FIELD OF THE INVENTION

The present invention relates to a network system for collecting advertisements to be attached to digital music and video content and distributing the digital content with the advertisement.

### BACKGROUND ART

In recent years, digital content, which is software of music, video or the like recorded as digital data (hereinafter referred to as “music/video content”), has become widespread. Duplication of such music/video content can be made without any degradation because it is in digital format. Therefore, a variety of measures for protecting against illegal duplication of such software has been proposed. Protection against illegal duplication is important, especially when the music/video content is at some cost to the provider.

However, to provide a system for protecting against illegal duplication of music/video content, a special mechanism is required in hardware and/or software. Therefore, the entire configuration of the system for providing and reproducing the music/video content becomes complicated, and such a system is not user-friendly. Specifically, for example, the system may become so complicated that the music/video content could not be obtained nor played unless a dedicated device is attached to the system, or a keyword and/or special command is input.

Furthermore, it is technically difficult to completely protect against illegal duplication. Even if a new copy protection system is devised, a countermeasure against such a system would be devised sooner or later.

In addition, when the music/video content is provided at some cost, a special mechanism needs to be provided in hardware and/or software for charging the end user who has received the music/video content. This results in an even more complex configuration of the entire system and further decreases the user-friendliness of the system.

Accordingly, there is a need for a system to be built which can adequately compensate a provider for its original content without imposing any restriction on its duplication, rather than protecting against illegal duplication.

As described above, digital content can be easily duplicated without degradation. Therefore, a variety of measures for protecting against such duplication have been implemented. However, the entire configuration of a system having such measures has become complicated, and the system has decreased its user-friendliness. In addition, it has been technically difficult to completely protect against illegal duplication. Furthermore, when digital content is provided for a charge, the entire system configuration has become even more complicated, and the user-friendliness of the system has again been decreased.

### SUMMARY OF THE INVENTION

The present invention solves these technical problems by providing a system which can protect a provider of original content while allowing duplication of the content to be made freely, rather than preventing the content from being duplicated. The present invention also provides a system for ensuring payment to the provider of the original content without the need for charging end users.

Furthermore, the present invention provides a place on a communication network where the provider of digital content and the provider of advertisement can negotiate with each other about monetary and other conditions for attaching an advertisement to digital content, so that the advertisement is attached to the digital content and a fee is paid to the provider of the digital content by the provider of the advertisement to ensure payment to the provider of the digital content.

To achieve these and other objects, the present invention is characterized in that it comprises a content providing terminal for use by a digital content provider, an advertisement providing terminal for use by a provider of advertising content to be attached to the digital content provided by the content providing terminal, and a server connected to the content providing terminal and to the advertisement providing terminal through the Internet for receiving the digital content from the content providing terminal, collecting the advertising content to be attached to the received digital content from the advertisement providing terminal, providing information to the provider of the digital content and the provider of the advertising content in order to form a contract between them, said information including a condition with regard to payment to the provider of the digital content, and publishing on the Internet the digital content with advertisement produced by combining the digital content with the advertising content. This configuration allows the digital content provider to be paid based on a contract made between the digital content provider and the advertising content provider.

Additionally, according to this configuration, once the digital content with advertisement has been published, there is no need for limiting duplication of the digital content because the digital content provider has already been paid and the advertising content provider wants many people to view and/or listen to the advertisement. Therefore, the present invention is very advantageous in that it does not require any copy protection mechanism in hardware and/or software.

The content providing terminal, the advertisement providing terminal, and the server communicate with each other by using a secure communication protocol. Specifically, a protocol such as SMIME or secure IP may be used.

In another aspect, the present invention is characterized in that it comprises a content providing terminal for use by a digital content provider, an advertisement providing terminal for use by a provider of advertising content to be attached to the digital content provided by the content providing terminal, a first server connected to the content providing terminal and the advertisement providing terminal through a communication network for receiving the digital content from the content providing terminal, and collecting advertising content to be attached to the received digital content from the advertisement providing terminal, and a second server for storing and publishing on the Internet the digital content with advertisement produced by combining the digital content received by the first server with the advertising content collected for attachment to the digital content, wherein the provider of the digital content and the provider of the advertising content establish a time condition in the collection of the advertising content at the first server, said time condition limiting a time period during which the digital content with the advertising content attached thereto may be published, and the second server publishes the digital content with advertisement in accordance with the time condition. This configuration advantageously allows the digital content to be downloaded to which a different advertisement is attached according to a time slot in which a general consumer (end user) accesses the content.

The providers of the digital content and the advertising content may establish, in the collection of the advertising content at the first server, a further condition concerning payment from the provider of the advertising content to the provider of the digital content. Thus the provider of the digital content can be compensated by contracting with the advertising content provider which attaches an advertisement to the digital content. This configuration advantageously eliminates the need for charging a general consumer who ultimately obtains the digital content.

In the above, the first and second servers merely represent a functional distinction and may be configured by the same hardware or server machine. If the first and second servers are configured by separate machines, they should be securely interconnected through a LAN or a leased line.

In a further aspect, the present invention is an auction server for supporting network auctions to receive bids for pricing an object to be auctioned through a communication network, which comprises registration means for receiving digital content and registering the digital content as an object to be auctioned, bid receiving means for collecting advertisement to be attached to the digital content registered as the object to be auctioned and receiving bids for pricing to attach the advertisement to the digital content, notification means for notifying a provider of the digital content and a provider of the advertisement who makes a successful bid for the digital content, of the result of the auction after the auction ends, and means for publishing the digital content with advertisement by attaching to the digital content the advertising content provided by the provider of the advertisement who has made a successful bid for the digital content at the auction. This configuration can provide a place on a communication network where a content provider and an advertisement provider negotiate about monetary and other conditions for attaching an advertisement to digital content.

The registration means accepts specified conditions for advertisement attachment when the digital content is registered as the object to be auctioned. The conditions include at least a time condition for limiting a time period during which the digital content with the advertisement attached thereto is published, and the publishing means publishes the digital content to which the advertisement is attached in accordance with the time condition specified when the digital content is registered as the object to be auctioned.

In a further aspect, the present invention is characterized in that it comprises means for collecting advertising content to be attached to music content including recorded digital data of music, means for combining the music content with the collected advertising content to produce music content with advertisement so that the advertisement is reproduced before, after, or during the performance of the music, and means for publishing on the Internet the music content with advertisement produced by the content combining means. The advertisement may be collected through a communication network. Specifically, for example, a list of music content for which advertisements are collected may be presented on the communication network to advertisement providers. A Web page, for example, may be used as means for presenting the music content on the communication network.

The advertisement collecting means may include means for specifying at least an insertion position of the advertisement to be attached to the music and a length of the advertisement as conditions for attaching the advertising content to the music content. When the list of music content is presented on the communication network to collect advertisements, conditions for attaching an advertisement may be presented for each item of music content.

In a further aspect, the present invention is characterized in that it comprises means for collecting advertising content to be attached to video content including recorded digital video data, means for combining the video content with the collected advertising content to produce video content with advertisement so that the advertisement is reproduced before, after, or during the playback of the video, and means for publishing on the Internet the video content with advertisement produced by the content combining means. The advertisement may be collected through a communication network as in the case of the music content. Specifically, for example, a list of video content for which advertisements are collected may be presented on the communication network to advertisement providers, in the form of Web page or the like.

The advertisement collecting means may include means for specifying at least an insertion position of the advertisement to be attached to the video content and a length of the advertisement as conditions for attaching the advertising content to the video content.

Furthermore, according to the present invention, the following digital content distributing method is provided. A method for distributing digital content through a communication network comprises the steps of collecting advertising content to be attached to digital content to be distributed under the condition of payment to a provider of the digital content, combining the digital content with the collected advertising content, and publishing on the communication network the digital content to which the advertising content is attached. Thus the provider of the digital content can receive payment by making a contract between the providers of the digital content and the advertising content for attaching an advertisement to the digital content. This procedure advantageously eliminates the need for charging a general consumer who ultimately obtains the digital content.

In the above, the collecting step comprises the steps of specifying advertisement attaching conditions for the digital content to be distributed, which conditions include at least a time condition for limiting a time period during which the digital content with advertisement is published and a positional condition for specifying a position in the digital content where the advertisement is inserted, and showing the digital content and the advertisement attaching conditions for the digital content to advertising content providers, wherein the publishing step publishes the digital content in accordance with the time condition included in the advertisement attaching conditions. Thus the digital content may be downloaded with a different advertisement being attached thereto according to a time slot in which general consumers access the content. This allows terms and conditions of a contract between the content provider and the advertisement provider to be diversified. For example, a higher content fee for attaching an advertisement may be set for a time slot during which the number of accesses is large.

Similarly, the terms and conditions of the contract may be diversified according to the position where an advertisement is inserted into the digital content. For example, a higher content fee may be set for an advertisement which is to be inserted before the digital content because such an advertisement may give a stronger impression on the audience.

The step of publishing the digital content on the communication network may comprise the steps of accepting through the communication network a request for sending the digital content, and sending the digital content to an information processing terminal issuing the request without charging. In this case, the provider of the digital content does not need to collect money from the general consumers since the provider has already received the content fee from the advertisement provider. Therefore, the digital content with the advertisement attached thereto can be advantageously distributed free of charge.

Furthermore, the present invention provides a method for distributing digital content through a communication network, comprising the steps of receiving and registering digital content to be distributed, performing an auction for advertisement providers on the communication network for attaching advertising content to the registered digital content, combining advertising content provided by an advertisement provider who has made a successful bid for the registered digital content with the digital content, and publishing on the communication network the digital content to which the advertising content is attached.

In the above, the step of registering the digital content may comprise the steps of specifying advertisement attaching conditions including at least a time condition for limiting a time period during which the digital content with the advertisement is published, and showing the registered digital content and the advertisement attaching conditions specified for the digital content to the advertisement providers, and the step of publishing the digital content on the communication network may publish the digital content in accordance with the time condition included in the advertisement attaching conditions. Thus the digital content may be downloaded with a different advertisement attached thereto according to a time slot in which general consumers access the content. This allows terms and conditions of a contract between the content provider and the advertisement provider to be diversified. For example, a higher content fee for attaching an advertisement may be set for a time slot during which the number of accesses is large.

Also, the step of publishing the digital content on the communication network may comprise the steps of receiving through the communication network a request for sending the digital content, and sending the digital content to an information terminal issuing the request, without limiting duplication of the digital content. Once the digital content with advertisement has been published, there is no need for limiting duplication of the digital content because the provider of the digital content has already received money and the provider of the advertising content desires that a lot of people view and/or listen to the advertisement. Therefore, this procedure is very advantageous in that it does not require any copy protection mechanism in hardware and/or software.

### BRIEF DESCRIPTION OF THE DRAWINGS

The present invention will now be described in detail below with respect to the preferred embodiments shown in the accompanying drawings, in which:

FIG. 1 is a diagram illustrating a general configuration of a network system in a preferred embodiment according to the present invention;

FIG. 2 illustrates a configuration of a Web page for an auction created at a BtoB server;

FIG. 3 is a flowchart describing a general flow of an advertisement collection service and a content providing service; and

FIG. 4 illustrates the flow of information and money in a network system of a preferred embodiment according to the present invention.

### DETAILED DESCRIPTION OF PREFERRED EMBODIMENTS

The present invention relates to a network system for performing services which collect advertisements to be attached to music/video content provided as digital data, attach an advertisement provided as digital data (hereinafter referred to as “advertising content”) to the music/video content when the advertisement is determined to be attached thereto, and provide the music/video content with advertisement as copy-free content.

The network system of the present invention can be divided into two services, i.e. an advertisement collecting service for registering music/video content and collecting advertisements to be attached to the music/video content, and a content providing service for providing the music/video content to which the advertisement is attached. These services may be implemented by, for example, a Business-to-Business (BtoB) server for registering music/video content and collecting advertisements, and a Business-to-Consumer (BtoC) server for distributing music/video content with advertisement to general users, respectively.

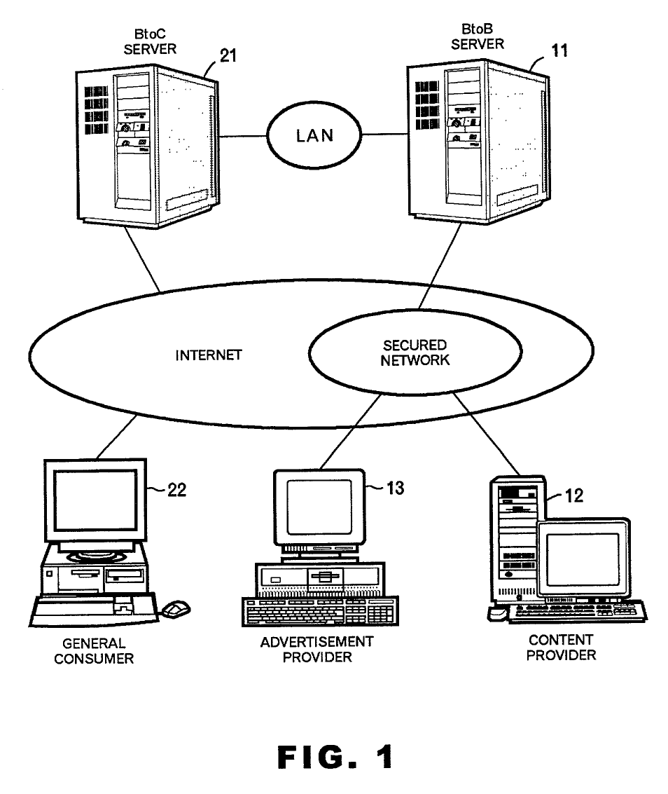

FIG. 1 is a diagram showing the entire network system according to the preferred embodiment. In FIG. 1, a BtoB server 11 registers music/video content and collects advertisements. A content provider terminal 12 sends original music/video content to the BtoB server 11 for registration. An advertisement provider terminal 13 provides advertising content to be attached to music/video content. A BtoC server 21 stores and distributes music/video content with advertisement. A general consumer terminal 22 receives desired music/video content with advertisement from the BtoC server 21 and plays it.

The BtoB server 11 is connected to the content provider terminal 12 and the advertisement provider terminal 13 through a communication network. The BtoB server 11 receives and registers music/video content from the content provider terminal 12, and collects advertising content to be attached to the music/video content from the advertisement provider terminal 13. The communication network may be a secured network using a leased line or a public network such as the Internet. If the Internet is used, however, secure communication should be assured by using a protocol such as SMIME or secure IP. In addition, it is preferable that access control should be implemented by issuing a user ID and password to each of the content provider and the advertisement provider.

The BtoC server 21 may be a conventional Web server which receives music/video content from the BtoB server 11 and distributes it through the Internet. The BtoB server 11 and the BtoC server 21 may be interconnected through a local area network (LAN) as shown in FIG. 1, or may be interconnected through a direct channel or a leased line. Also, they may be interconnected through the Internet if secure communication is assured as in the connection of the BtoB server 11 with the content provider terminal 12 and the advertisement provider terminal 13. The BtoB server 11 and the BtoC server 21 may be implemented physically by the same hardware (server machine).

The general consumer terminal 22 may be an information processing system such as a personal computer or a PDA which uses a Web browser to obtain music/video content with advertisement from the BtoC server 21 over the Internet.

In the network system shown in FIG. 1, the BtoB server 11 provides an advertisement collecting service and the BtoC server 21 implements a content providing service. Each of these services will be described below.

First, the advertisement collecting service is described. In the present embodiment, advertisements are collected by auction on the network, though they may be collected in various ways.

A plurality of advertisements may be allocated to the same music/video content in separate time slots, respectively. That is, a plurality of time slots are set for the same music/video content to collect a plurality of advertisements to be attached to the music/video content. In that case, when the music/video content is distributed, a different advertisement would be attached thereto depending on the time slot during which the content is accessed. The time slot in which an advertisement is attached may be determined at the BtoB server 11 or may be negotiated by the content provider and the advertisement provider.

The procedure for auctioning on the network will be described below. It is assumed herein that the BtoB server 11 is a Web server to which an auction capability is added by using middleware or the like, and that each of the content provider terminal 12 and the advertisement provider terminal 13 is an information processing system such as personal computer on which a Web browser is installed. It is also assumed that the BtoB server 11, the content provider terminal 12, and the advertisement provider terminal 13 are interconnected through the Internet where secure communication therebetween is assured by using a protocol such as SMIME or secure IP.

First, a content provider uses the content provider terminal 12 to send its original music/video content to the BtoB server 11 and registers it as an object to be auctioned. At that time, the content provider can specify conditions for attaching an advertisement to the music/video content. Typically, the content provider specifies general conditions such as the maximum amount of time during which an advertisement continues, whether an advertisement may be inserted in the middle of the music/video content, and the minimum price. Bidding is then performed based on these conditions.

Once the BtoB server 11 accepts the registration of music/video content from the content provider terminal 12, it presents the music/video content on a Web page for auction as an exhibit therefor to allow advertisement providers to browse it.

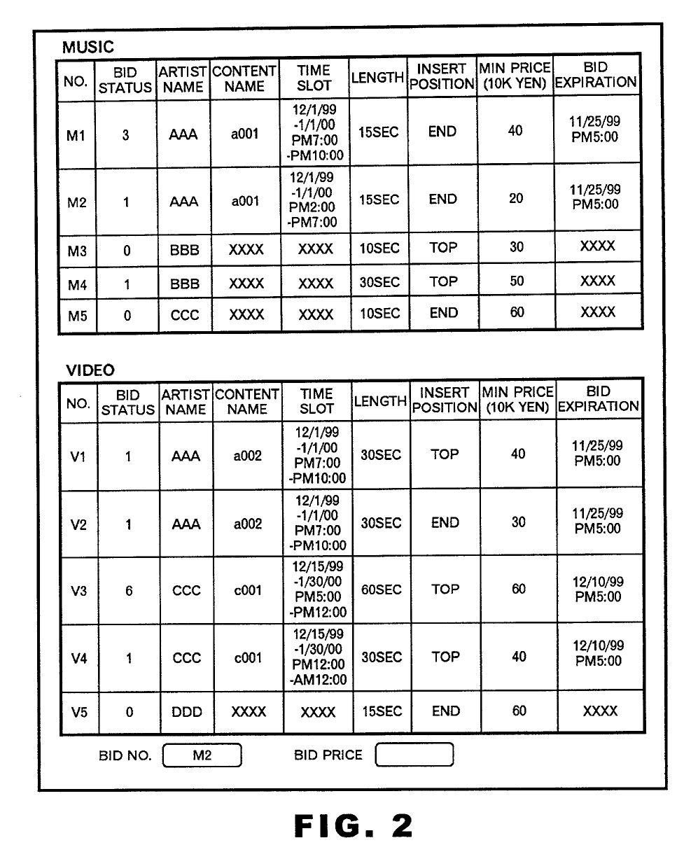

FIG. 2 shows an example of one possible configuration of an auction Web page used by the BtoB server 11. The auction Web page shown in FIG. 2 provides a list of music/video content registered in the BtoB server 11. For each of the music content and video content, artist and content names are presented and conditions such as time slot during which an advertisement can be attached, length of an advertisement to be attached, insertion position (where, in music/video content, an advertisement is inserted), minimum price, and bid expiration or deadline (time period of auction) are presented. For example, the music content labeled with a content number “M1” is of the artist name “AAA” and content name “a001”, and the time slot “p.m. 7:00 to p.m. 10 on everyday from Dec. 1, 1999 through Jan. 1, 2000”, length of advertisement “15 seconds”, insertion position “end of content”, minimum price “400,000 yen”, bid expiration “p.m. 5:00 on Nov. 25, 1999” are presented as conditions. Even the same music/video content is treated as different content in the auction Web page shown in FIG. 2 if its time slot is different. For example, two slots having the content numbers “M1” and “M2” represent the same music/video content (with the same artist and content names). This content is registered in different entries because the time slot of “M1” is from p.m. 7 to p.m. 10 while the time slot of “M2” is from p.m. 2 to p.m. 7.

It should be noted that the items shown in FIG. 2 are merely illustrative. Any conditions for attaching advertisement to music/video content and any other items may be presented on the list. For example, a content author name may be contained in place of an artist name, and the maximum price may be specified rather than the minimum price depending on the form of auction. The content provider may add an item that limits advertisement providers. Furthermore, a different condition item may be provided for each slot of content.

Next, an advertisement provider (advertiser or advertisement agency) uses the advertisement provider terminal 13 to browse the auction Web page and bid (price) for desired music/video content. In the example of FIG. 2, there are three bids for the music content having the content number “M1”. When music/video content is newly presented on the auction Web page, the bid status column of the music/video content is set to “0”. The advertisement provider can browse the details of other bids for the music/video content for which the advertisement provider wants to bid.

In addition, when the advertisement provider bids for any given music/video content, proposed advertising content to be attached to the music/video content is sent to the BtoB server 11.

The auction ends when the term of validity of bidding for the music/video content expires. Then, it is determined if an advertisement of an advertisement provider that made the highest bid is attached to the music/video content. If there has been no bid within the term of validity, no deal is made.

On the other hand, if a deal is made, the music/video content, the advertising content, and spot schedule information indicating a time slot are sent to the BtoC server 21, and the content provider and the advertisement provider are notified that the deal has been made.

In addition, if a deal is made, the advertisement provider pays the content provider a content fee. The content provider obtains a return for the content by this content fee. Any method for paying the content fee may be used without restriction. Payment may be performed through a network or by any other common method.

Next, the content providing service is described.

First, the BtoC server 21 stores the music/video content, advertising content, and spot schedule information which is sent from the BtoB server 11. Then, the music/video content is combined with the advertising content by the B to C Server 21 to produce music/video content with advertisement. The advertising content itself is digital content containing audio and/or video data. Therefore, typically audio advertising content may be attached to music content and video advertising content may be attached to video content. However, video advertising content may be attached to music content or music advertising content may be attached to video content, depending upon the agreement between the content provider and advertisement provider.

The BtoC server 21 performs time management for publishing the produced music/video content with advertisement according to the spot scheduling information. That is, it publishes the music/video content with advertisement on a content providing Web page in a time slot specified by the spot schedule information to make it available to general consumers. Thus the general consumer terminal 22 can be used to access the music/video content only in the time slot specified by the spot schedule information.

Referring to FIG. 2, the music content numbers “M1” and “M2” represent the same content but their time slot conditions are different. Therefore, if a given advertisement provider C-A has made a successful bid for “M1” while another advertisement provider C-B has made a successful bid for “M2”, the music/video content distributed contains the same music or video; but the advertising content provided by the advertisement provider C-A is attached from p.m. 7 to p.m. 10:00; and the advertising content provided by the advertisement provider C-B is attached from p.m. 2:00 to p.m. 7:00.

A general consumer uses the general consumer terminal 22 to browse the content providing Web page of the BtoC server 21 over the Internet and to download desired music/video content. In the example described above, if a general consumer who wants to obtain the music content “a001” of the artist “AAA” accesses the content in a time period from p.m. 7:00 to p.m. 10:00, the consumer would obtain the music content with the advertising content provided by the advertisement provider C-A, and if the consumer accesses it in a time period from p.m. 2:00 to p.m. 7:00, the consumer would obtain the music content with the advertising content provided by the advertisement provider C-B.

In the present embodiment, the music/video content with advertisement is provided to general consumers free of charge. As described above, the content provider received payment for the music/video content from the advertisement provider at the time when the contract for attaching the advertisement to the music/video content was made. Therefore, the general consumer needs not pay any charge for the music/video content with advertisement obtained from the BtoC server 21. Because the general consumer is not charged, no system for charging for the content is required on the general consumer terminal 22.

When the music/video content with advertisement is downloaded by the general consumer terminal 22, the BtoC server 21 obtains the access information. Customer information about a general consumer who has accessed the content can be collected by using any known technique, such as a Cookie. In addition, information about access status (audience rating) can be collected, such as which music/video content was downloaded and how many times, and in which time slot the content was most frequently downloaded. The collected information may be optionally provided to the content provider and the advertisement provider. The content provider and the advertisement provider can use the received information for their marketing activities.

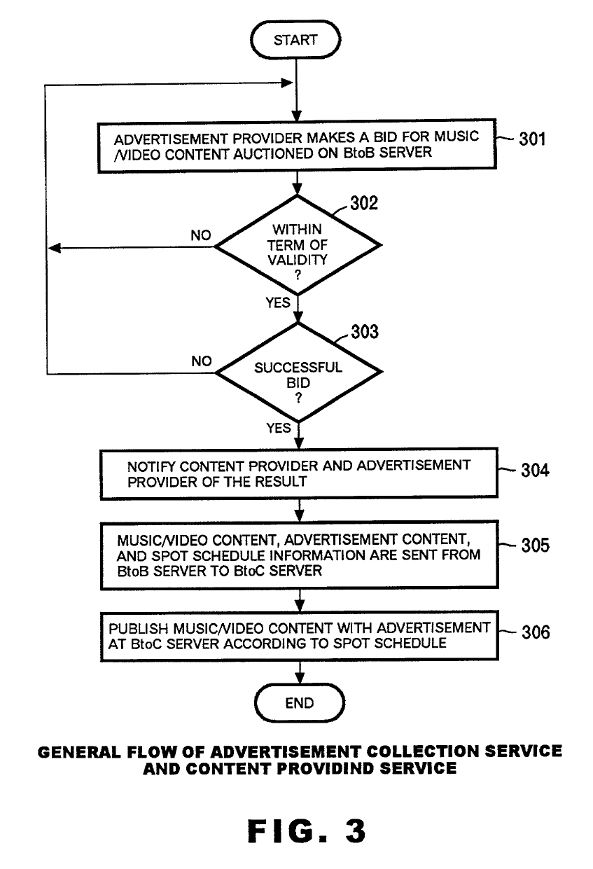

FIG. 3 shows a flowchart of the advertisement collection service and content providing service described above. It is assumed, as an initial state, that music/video content has been uploaded from a content provider terminal 12 to the BtoB server 11 and registered in a Web page for auction. When a given advertisement provider terminal 13 is used to make a bid for given music/video content (step 301), a contract for attaching an advertisement to the music/video content may be made after the bid time expires for the music/video content (steps 302, 303). Then, the content provider of the contracted music/video content and the advertisement provider are notified that the contract has been made (step 304). Further, the music/video content, the advertising content, and spot schedule information are sent from the BtoB server 11 to the BtoC server 21 (step 305).

Subsequently, in the BtoC server 21, the music/video content and the advertising content are combined and published according to the spot schedule.

While, in the service provided by the above-described network system, the music/video content, the advertising content, and the spot schedule information are sent from the BtoB server 11 to the BtoC server 21 and the music/video content and advertising content are combined together at the BtoC server 21, they may be combined with each other at the BtoB server 11 to produce the music/video content with advertisement and the produced music/video content with advertisement and the spot schedule information may be sent to the BtoC server 21.

Furthermore, while, in the above-described service, a content fee is paid by the advertisement provider to the content provider at the time when the contract for attaching an advertisement to the music/video content is made, a fixed charge may be paid by the advertisement provider to the content provider each time the music/video content with advertisement is downloaded to the general consumer terminal 22 once it has been uploaded to the BtoC server 21.

The provider of the BtoB server 11 and the BtoC server 21 may collect service fees for providing the above-described advertisement collection and content providing services, as needed.

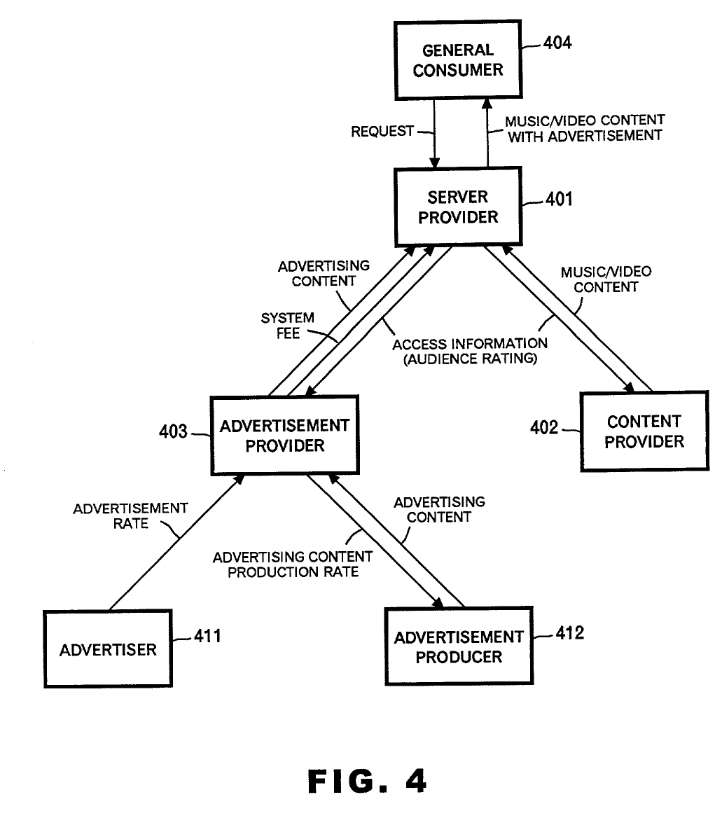

FIG. 4 is a diagram for explaining the general flow of information and fees or rates in the network system of the present embodiment. A content provider (copyright owner of music/video content) 402 uploads its music/video content to the BtoB server 11 and obtains access information of a general consumer 404. An advertisement provider 403 uploads advertising content to the BtoB server 11 and obtains access information of the general consumer 404. The general consumer 404 sends an access request (a request for obtaining music/video content) to the BtoC server 21 and downloads the music/video content with advertisement. The access request sent from the general consumer 404 to the BtoC server 21 is collected, processed, and provided to the content provider 402 and the advertisement provider 403 as the access information.

A server provider 401 of the BtoB server 11 and the BtoC server 21 may collect service fees or charges from the content provider 402 and the advertisement provider 403. Any method may be used for charging. For example, part (predetermined percentage) of a contracted price may be collected when a contract is made at auction. Alternatively, a membership system may be employed and a monthly or annual charge may be collected from each member including the content provider 402 and the advertisement provider 403. Various methods for collecting service charges may be used, including credit services, direct charging from a bank account, and other commonly used methods.

As described earlier, a content fee is paid from the advertisement provider 403 to the content provider 402. If the advertisement provider 403 is an advertising agency, an advertiser 411 pays expenses including advertisement rate to the advertising agency. If a given advertisement producer 412 creates advertising content at the request of the advertisement provider 403, the advertisement provider 403 pays the advertisement producer 412 a production fee or rate of the advertising content.

According to the present embodiment, the content provider 402 receives payment for its music/video content at the time when a contract for attaching an advertisement to the content is made because a content fee is paid from the advertisement provider 403 to the content provider 402. This means that there is no necessity to request payment for the music/video content when the general consumer 404 downloads the music/video content with advertisement. Therefore, if the copyright owned by the content provider 402 is ensured, there would be no necessity for restricting duplication of music/video content with advertisement once the music/video content with advertisement has been published on the BtoC server 21. Rather, allowing duplication and distribution of music/video content will result in the music/video content gaining publicity.

It is also favorable to the advertisement provider 403 that the music/video content with advertisement published on the BtoC server 21 is duplicated at a site where it is downloaded and distributed to others because the advertisement is also duplicated and distributed together with the content.

In addition, there is no need to provide a special hardware or software mechanism in the general consumer terminal 22 to protect music/video content against duplication because duplication of the downloaded music/video content with advertisement is unrestricted. Therefore, the resulting system is not complicated nor cumbersome for the general consumer 404. Furthermore, the general consumer 404 does not need to follow a complicated procedure when downloading music/video content with advertisement because the general consumer 404 is not charged for obtaining the music/video content with advertisement. Therefore, it is facilitated to download desired music/video content.

The system according to the present embodiment is constructed with the assumption that a general consumer views and/or listens to an advertisement attached to desired music/video content when he/she views and/or listens to the music/video content. Therefore, it is undesirable to allow separation of the advertising content from the music/video content or to allow the consumer to skip the advertisement during playback of the music/video content. Accordingly, some mechanism for preventing such operations should be provided. While any technique may be used to prevent separation or skipping of the advertising content, a method for providing an executable program containing music/video content and advertising content will be illustrated below.

A program containing music/video content and advertising content is obtained and executed on a general consumer terminal to thereby force playback of the advertising content. This kind of program may be in any form. It may be provided as a Java applet.

The program may contain an expiration date for program usage and a counter for counting playback times to indicate how many times the content can be played hereafter. When the expiration date has passed or when the counter has reached “0”, the program cannot run anymore. If the user wants to view and/or listen to the same music/video content after the program is inhibited from running, the user may download the content from the BtoC server again. In that case, it is likely that a different advertisement is attached to the same music/video content because the content is downloaded at a different time. Therefore, more advertisements may be distributed which is desirable for the advertisement providers.

Negotiation of prices (spot prices) at the auction will be considered below. As described above, the negotiation may be started from the minimum price and the price may be bid up gradually, or started from the maximum price and the price may be lowered gradually. In either case, the price is determined according to supply and demand on the market.

Pricing may depend on the following factors.

A first factor is popularity of the music/video content. For example, a content price may become higher as popularity of its artist increases. Also, different prices may be set for popular music/video content and unpopular music/video content, respectively, even if they are works of the same artist.

Furthermore, even for the same music/video content, the price may become higher in a time slot during which a larger number of accesses are made over the Internet. This is similar to prime time of television broadcast. However, considering time differences on the Internet which can be accessed from anywhere in the world, prime time of the Internet may not be determined as simply as that of a television broadcast. This factor would be established according to actual market conditions after the service is put into practice.

The length (amount of time) of advertising content and the position where an advertisement is inserted may also be a factor for setting the price. For example, the price may become higher as the advertisement is longer because the advertisement attached to the music/video content is not an essential component of the latter.

Similarly, the price may become higher in the case where the advertisement is inserted just before or in the middle of the music/video content than the case where it is placed after the music/video content because the advertisement should be actually viewed and/or heard when the music/video content is played.

However, influence of these factors may not be clear because inserting an advertisement just before or in the middle of music/video content or inserting a too long advertisement would lessen interest of a viewer/listener (general consumer) and the music/video content itself would become unpopular.

On the other hand, if the advertising content is suited for the music/video content, the music/video content may rise in popularity by a synergy effect.

In any case, these factors would be established according to actual market conditions through trial and error after the service is put into practice.

The above-mentioned factors considered in negotiating the price at the auction are just examples. Other factors, such as distribution of duplications of downloaded music/video content, may be considered as the service is put into practice. These factors can be incorporated into the system by, for example, listing them as condition items presented on the auction Web page shown in FIG. 2. Preferably, condition items for the auction can be added and/or changed flexibly according to, for example, content provider's requests, intention of the provider of BtoB and BtoC servers, and/or negotiations between the content provider and the advertisement provider.

While in the above-described embodiments, the auction has been illustrated for collecting advertisements, it is also possible to implement other embodiments for providing a place where a music/video content provider and an advertising content provider negotiate about conditions including a monetary one for attaching an advertisement to music/video content.

As described above, the present invention provides a system which can protect a provider of original digital content while allowing duplication of the content to be made freely rather than preventing the duplication.

Furthermore, the present invention provides a system which allows the provider of original content to receive payment without the need for charging end users.

The present invention also provides a place on a communication network where an original content provider and an advertisement provider can negotiate about monetary and other conditions for attaching an advertisement to digital content.

What is claimed:

1. A network system, comprising:
a content providing terminal for use by a digital content provider;
an advertisement providing terminal for use by a provider of advertising content to be attached to digital content provided by said content providing terminal; and
a server connected to said content providing terminal and said advertisement providing terminal through the Internet for receiving said digital content from said content providing terminal, collecting said advertising content to be attached to the received digital content from said advertisement providing terminal, providing information to the provider of said digital content and the provider of said advertising content for making a contract between the provider of said digital content and the provider of said advertising content, said information including a condition with regard to payment to the provider of said digital content, and publishing on the Internet the digital content with advertisement produced by combining said digital content with said advertising content between which said contract has been made.

2. The network system according to claim 1, wherein said content providing terminal, said advertisement providing terminal, and said server communicate with each other by using a secure communication protocol.

3. A network system, comprising:
a content providing terminal for use by a digital content provider;
an advertisement providing terminal for use by a provider of advertising content to be attached to the digital content provided by said content providing terminal;
a first server connected with said content providing terminal and said advertisement providing terminal through a communication network for receiving said digital content from said content providing terminal, and collecting said advertising content to be attached to the received digital content from said advertisement providing terminal; and
a second server for storing and publishing on the Internet the digital content with advertisement produced by combining said digital content received by said first server with said advertising content collected for attachment to said digital content;
wherein the provider of said digital content and the provider of said advertising content establish a time condition in the collection of said advertising content at said first server, said time condition limiting a time period during which said digital content with said advertising content attached thereto may be published, and said second server publishes said digital content with advertisement in accordance with said time condition.

4. The network system according to claim 3, wherein the provider of said digital content and the provider of said advertising content further establish, in the collection of said advertising content at said first server, a condition with regard to payment to the provider of said digital content from the provider of said advertising content.

5. The network system according to claim 3, wherein said first server and said second server are configured by the same hardware.

6. An auction server for supporting a network auction to receive bids for pricing an object to be auctioned through a communication network, said auction server comprising:
registration means for receiving digital content and registering said digital content as an object to be auctioned;
bid receiving means for collecting advertisement to be attached to said digital content registered as the object to be auctioned and receiving bids for pricing to attach said advertisement to said digital content;
notification means for notifying a provider of said digital content and a provider of said advertisement who makes a successful bid for said digital content, of the result of the auction after the auction ends; and
digital content with advertisement publishing means for publishing said digital content to which advertising content is attached, said advertising content being provided by the provider of said advertisement who has made a successful bid for said digital content at said auction.

7. The auction server according to claim 6, wherein said registration means accepts specified conditions for advertisement attachment when said digital content is registered as the object to be auctioned, said conditions including at least a time condition for limiting a time period during which said digital content with said advertisement attached thereto is published, and said publishing means publishes said digital content to which said advertisement is attached in accordance with said time condition specified when said digital content is registered as the object to be auctioned.

8. A system for distributing digital content, comprising:
means for collecting advertising content to be attached to music content including recorded digital data of music;
means for combining said music content with said collected advertising content to produce music content with advertisement so that the advertisement is reproduced before, after, or during the performance of the music; and
means for publishing on the Internet said music content with advertisement produced by said content combining means.

9. The digital content distributing system according to claim 8, wherein said collecting means comprises means for specifying at least an insertion position of said advertisement to be attached to said music and a length of said advertisement as conditions for attaching said advertising content to said music content.

10. A system for distributing digital content, comprising:
means for collecting advertising content to be attached to video content including recorded digital video data;
means for combining said video content with said collected advertising content to produce video content with advertisement so that the advertisement is reproduced before, after, or during the playback of the video; and
means for publishing on the Internet said video content with advertisement produced by said content combining means.

11. The digital content distributing system according to claim 10, wherein said collecting means includes means for specifying at least an insertion position of said advertisement to be attached to said video and a length of said advertisement as conditions for attaching said advertising content to said video content.

12. A method for distributing digital content through a communication network, comprising the steps of:
collecting advertising content to be attached to digital content to be distributed under a condition of payment to a provider of said digital content;
combining said digital content with said collected advertising content; and
publishing on said communication network said digital content to which said advertising content is attached.

13. The digital content distributing method according to claim 12, wherein said collecting step comprises the steps of:
specifying advertisement attaching conditions for said digital content to be distributed, said conditions including at least a time condition for limiting a time period during which said digital content with the advertisement is published and a positional condition for specifying a position in said digital content where said advertisement is inserted; and
showing said digital content and said advertisement attaching conditions for said digital content to advertising content providers;
wherein said publishing step publishes said digital content in accordance with said time condition included in said advertisement attaching conditions.

14. The digital content distributing method according to claim 12, wherein said publishing step comprises the steps of:
accepting through said communication network a request for sending said digital content; and
sending said digital content to an information processing terminal issuing said request without charging.

15. A method for distributing digital content through a communication network, comprising the steps of:
receiving and registering digital content to be distributed;
performing an auction for advertisement providers on the communication network for attaching advertising content to said registered digital content;
combining advertising content provided by an advertisement provider who has made a successful bid for said registered digital content with said digital content; and
publishing on the communication network said digital content to which said advertising content is attached.

16. The digital content distributing method according to claim 15, wherein said registering step comprises the steps of:
specifying advertisement attaching conditions including at least a time condition for limiting a time period during which said digital content with the advertisement is published; and
showing said registered digital content and said advertisement attaching conditions specified for said digital content to said advertisement providers;
wherein said publishing step publishes said digital content in accordance with said time condition included in said advertisement attaching conditions.

17. The digital content distributing method according to claim 15, wherein said publishing step comprises the steps of:
receiving through said communication network a request for sending said digital content; and
sending said digital content to an information processing terminal issuing said request, without limiting duplication of said digital content.
